(19) United States
(12) Patent Application Publication
(10) Pub. No.: US 2020/0334519 A1
(43) Pub. Date: Oct. 22, 2020

(54) Learning View-Invariant Local Patch Representations for Pose Estimation

(71) Applicant: Siemens Aktiengesellschaft, Munich (DE)

(72) Inventors: Georgios Georgakis, Manassas, VA (US); Srikrishna Karanam, Plainsboro, NJ (US); Varun Manjunatha, Princeton, NJ (US); Kuan-Chuan Peng, Plainsboro, NJ (US); Ziyan Wu, Princeton, NJ (US); Jan Ernst, Princeton, NJ (US)

(21) Appl. No.: 16/954,547

(22) PCT Filed: Jan. 11, 2018
(86) PCT No.: PCT/US2018/013271

§ 371 Date: Jun. 17, 2020

(51) Int. Cl. G06N 3/04; G06N 3/08; G06T 7/73; G06T 7/136

(52) U.S. Cl. CPC G06N 3/0454; G06N 3/08; G06T 2207/20084; G06T 7/136; G06T 2207/20081; G06T 7/74

(57) ABSTRACT

A method for learning image representations comprises receiving a pair of images, generating a set of candidate patches in each image, identifying features in each patch, arranging the patches in pairs and comparing a distance between a feature in the first image to a feature in the second image. The pair of patches is labeled as positive or negative based on the comparison of the measured distance to a threshold. Images may be depth images and distance is determined by projecting the features into three-dimensional space. A system for learning representations includes a computer processor configured to receive a pair of images to a Siamese convolutional neural network to generate candidate patches in each image. A sampling layer arranges the patches in pairs and measures distances between features in the patches. Each pair is labeled as positive or negative according to the comparison of the distance to a threshold.

### TECHNICAL FIELD

This application relates to analysis of digital images. More specifically, the application relates to the identification of objects within a digital image.

### BACKGROUND

In an attempt to visually identify objects or features in a given space using automated systems, digital images of the space may be captured by an image sensing device. The digital images contain information representative of a field of view of the image sensing device, including objects that exist within the field of view. In addition to visual data, such as pixels representing the form and color of an object, other information may be included in a digital image. For example, three-dimensional (3D) information, including depth information relating to objects or features represented in the digital image may be included.

Frequently it may useful to analyze digital images to identify objects captured in the image. While objects may often be identifiable when the digital image is viewed by a human, there are applications where it is desired that the analysis and identification of objects within an image is performed by machines. For example, convolutional neural networks (CNNs) are sometimes used to analyze visual imagery. The identification of objects using machines is complex, as a machine must learn the properties that identify an object and correlate that information to the digital representation of the object in the image. This becomes even more challenging because a given object may be viewed by the image capture device from different perspectives relative to the object. A given perspective defines the object's pose, and objects may appear substantially different depending on the object pose in combination with the angle from which the object is viewed.

Typically, object pose estimation is performed by computing an image representation and searching a pre-existing database of image representations based on known poses. The database is constructed from a training set using machine learning techniques. A popular machine learning method for obtaining the representations is through convolutional neural networks, which may be trained in an end-to-end fashion. Adding to the challenge of identifying features in an image for practical applications, depth images are often cluttered with noise and spurious background information, rendering the global image representation ineffective. This may result in an inaccurate representation of the object. Methods and systems are desired to learn image representations that are not influenced by spurious background and noise present in depth images.

### SUMMARY

According to a method for learning view-invariant representations in a pair of images, the method comprises receiving a pair of images from a pair of image capture devices, generating a plurality of candidate patches in each image in the pair of images, arranging each of the candidate patches of a first image of the pair with each of the candidate patches of a second image of the pair of images to create a plurality of patch pairs, identifying features in the patches of each patch pairs, measuring a distance between a feature of the first patch in the patch pair to a corresponding feature of the second patch in the patch pair, comparing the distance between corresponding features in the patches of each pair of patches to a threshold, and labeling the pair of patches as positive or negative based on the comparison of the distance to the threshold.

According to an embodiment, each image of the pair of images is a depth image.

According to an embodiment, the method may further comprise projecting the identified features in the patches into three-dimensional space.

According to an embodiment, the method may further comprise labelling a patch pair as positive if the measured distance is less than the threshold and as negative if the measured distance is greater than the threshold.

According to an embodiment, the method may further comprise receiving intrinsic information relating to the image capture device used to capture the corresponding received image.

According to an embodiment, receiving the pair of images further comprises receiving pose information relating to the spatial position of the image capture device that captured the image.

According to an embodiment, the identified features are stored as a feature vector.

According to an embodiment, the method may further comprise outputting a set of labeled patch pairs, each labeled patch pair comprising a patch pair label identifying the patch pair, feature vectors associated with the patch pair, and a positive/negative label indicative of a correlation of a feature identified in the first patch of the patch pair and a feature identified in the second patch of the patch pair.

According to an embodiment, the plurality of candidate patches of the first image and the second image are generated by a pre-trained convolutional neural network (CNN).

According to an embodiment, the candidate patches of the first image are generated by a first CNN and the candidate patches of the second image are generated by a second CNN, the first and second CNNs being arranged in a Siamese network configuration.

According to an embodiment, the plurality of candidate patches of the first image and the candidate patches of the second image are selected based on a likelihood that the patch contains an object of interest captured in the image.

According to an embodiment, the pair of images are captured from one given space, and the first image is captured from a first perspective and the second image is captured from second perspective.

According to an embodiment, the method may further comprise providing a set of labeled patches to a visual analysis application.

According to an embodiment, the method may further comprise receiving an image in the visual analysis application, analyzing the received image to identify patches of interest in the received image that has a given likelihood to contain an object of interest, and comparing the patches of interest to a set of labeled patches to identify the object of interest.

According to an embodiment, the method may further comprise estimating an object pose in the received image based on the comparison to the set of labeled patches.

According to a system for generating view invariant image patch representations, the system comprises a first image capture device and a second image capture device. A Siamese convolutional neural network is configured to receive a first image from the first image capture device and a second image from the second image capture device and generate a plurality of candidate patches. A sampling layer is configured to receive a plurality of candidate patches from a first CNN, and a plurality of candidate patches from the second CNN, the sampling layer arranges the candidate patches in pairs, compares distances between features in each patch of the pair of patches and labels each pair of patches as positive or negative based on a comparison of the distances to a threshold. In an embodiment, the system further comprises a set of weights applied to the first CNN and the second CNN. According to another embodiment, the system comprises a visual analysis application configured to receive a set of labeled patches and an image, the visual analysis application configured to identify a pose of an object of interest in the image based on a comparison of the image to the set of labeled patches. In an embodiment, the system may further comprise a set of labeled patch pairs created by the sampling layer. Each labeled patch pair comprises a label identifying the first patch and the second patch associated with the patch pair, a first feature vector associated with the first patch, a second feature vector associated with the second patch, and a binary label associated with the pair of patches, the binary label indicative of a positive or negative correlation between the first feature vector and the second feature vector. According to aspects of another embodiment, the system further comprises a visual analysis application configured to receive the set of labeled patches and a captured image and produce an object pose for an object in the captured image based on the set of labeled patches.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram of a process for view invariant learning of patch representations for pose estimation according to aspects of embodiments of the present disclosure.

FIG. 2 is a block diagram of a sampling layer for view invariant learning of patch representations for post estimation according to aspects of embodiments of the present disclosure.

FIG. 3 is an illustration of a box representation as a tuple and the representation of a pair of boxes along with an indicator of whether the pairs of tuples represent the same object according to aspects of embodiments of this disclosure.

FIG. 4 is a depth image indicating candidate patches or boxes within the depth image according to aspects of embodiments of this disclosure.

FIG. 5 is a pair of depth images indicating showing corresponding features according to aspects of embodiments of the present invention.

FIG. 6 is a process flow diagram for learning of view-invariant representations for depth images according to aspects for embodiments of this disclosure.

FIG. 7 is a block diagram of a computer system for learning view-invariant local patch representations for estimating pose of objects within depth images according to aspects of embodiments of this disclosure.

### DETAILED DESCRIPTION

To address the above challenges affecting the learning of representations in depth images, an approach for learning useful local patch representations that can be matched among images from different viewpoints of the same object is described herein. The local patches and their representations are generated from a deep convolutional network that is pre-trained for generating object proposals. Patches represent contiguous groups of pixels which include a subset of pixels in the entire captured image. Patches may be selected such that selected patches are more likely to contain features of interest in the space captured in the depth image. Throughout this description, the term patch(es) and box(es) are used interchangeably to identify a region of a depth image, the region being a subset of the full image.

According to embodiments of this disclosure, two depth images are captured from a given space, the two depth images being captured from different perspectives. Boxes contained in the two depth images are analyzed to identify candidate regions of the images that may contain features of the captured space that are of interest for identification or further analysis. After establishing pairs between patches of the two images from different poses, analysis is performed with the goal of minimizing a distance in feature space between patches that constitute correspondences (a positive correlation), and maximizing a distance between non-correspondence patches (a negative correlation). Using two test images, local patches are generated in each test image, and a nearest neighbor search of the learned features space is performed to find reliable matches. Once reliable matches are identified, the exact relative pose between the two images may be estimated based on the feature vectors of the corresponding patch pair. An approach for learning view-invariant local patch representations for use in 3D pose estimation based on depth images captured using structured light sensors will now be described.

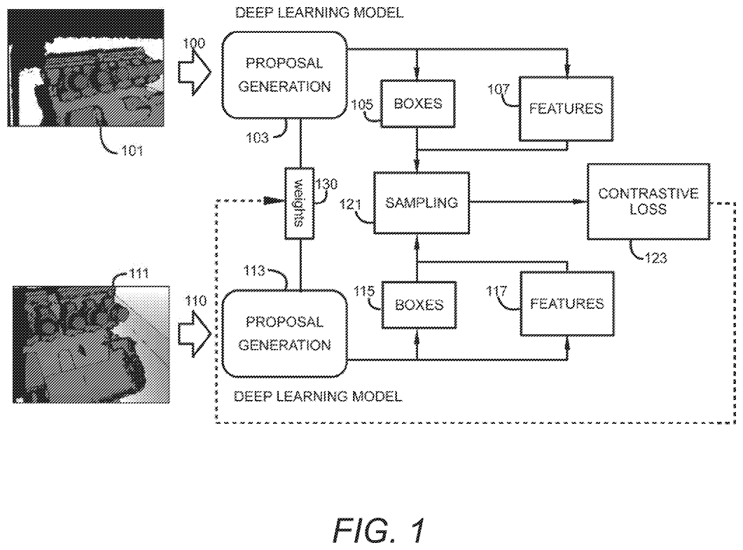

FIG. 1 is a block diagram of an architecture for learning view-invariant representations of depth images for pose estimation according to aspects of embodiments of this disclosure. A Siamese network architecture is defined to receive as input a pair of depth images including pose annotations for each image. Each branch 100, 110 of the architecture is a proposal generation network 103, 113, which is used to generate patches (or boxes) 105, 115 on the two depth images 101, 111. The proposal generation network 103, 113 is a pre-trained neural network used to classify regions of the image into areas that are likely to contain features of interest in the image. The outputs of the proposal generation network 103, 113 are patches or boxes 105, 115 considered to contain features of interest. Each box 105, 115 is associated with a set of numeric values that are representative of features 107, 117 identifiable within the box 105, 115. For example, features may include numeric representations of depth, color, intensity, contrast or other identifying aspects of features of objects in the depth images 101, 111. The branches 100, 110 of the Siamese neural network share a set of common weights 130 and converge to a sampling layer 121. The sampling layer is configured to form pairs of patches between the two images 101, 111. The sampling layer then labels each pair as either positive or negative, depending on the proximity of corresponding features of each box in the pair as projected in the 3D space. In other words, the sampling layer 121 is used to create ground truth data on-the-fly taking advantage of the initial pose annotations of the images 101, 111.

The network may be further trained using a contrastive loss technique 123, which attempts to minimize the distance in the feature space between positive pairs, and maximize the distance between negative pairs. The contrastive loss function 123 further provides feedback for adjusting weights 130 used by the two branches 100, 110. Accordingly, for patches that are very close in the 3D space but sampled from different image perspectives, a representation may be learned that has a minimal distance in the feature space.

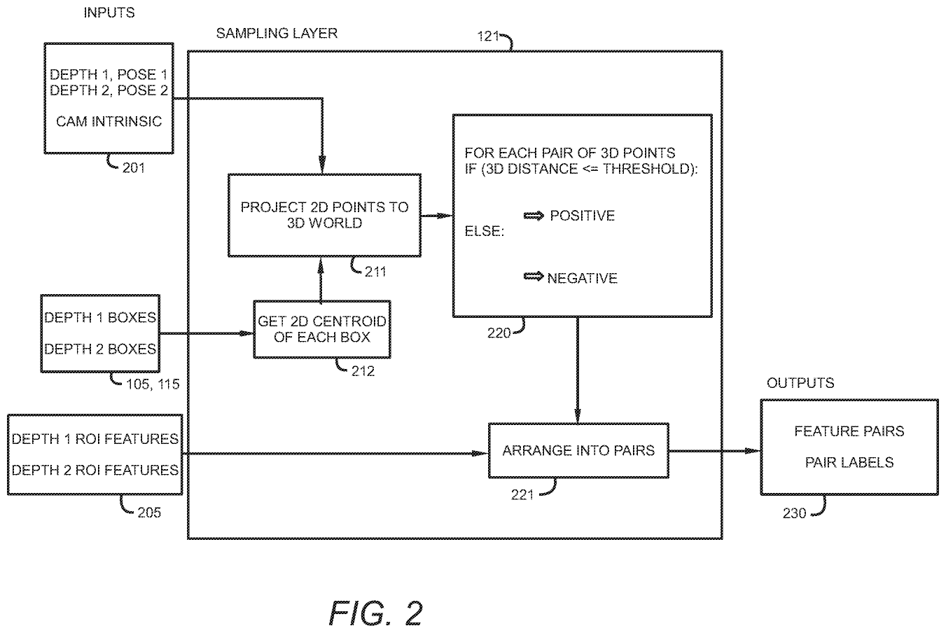

FIG. 2 is a block diagram of the sampling layer 121 shown in the architecture of FIG. 1. The sampling layer 121 receives as inputs, two depth images 201 that include annotations relating to the pose depicted in each depth image and intrinsic information relating to the image capture device that captured the depth images along with absolute distance values of the two depth images. Given to pose annotations for each image, the centroid of each box is projected into the 3D space. The architecture containing the sampling layer 121 includes a proposal generation component that produces a number K, of top scoring patches or boxes 105, 115 from the depth images 201 that contain features of interest in the depth images 201. Numeric data comprising representations of the selected patches 105, 115 are configured as feature vectors for each region of interest (ROI) 205, the feature vectors, in addition to the patch designations 105, 115 are input to the sampling layer 121. The scores of the patches are determined by the proposal generation networks 103, 113 as shown in FIG. 1. Initially, the sampling layer 121 calculates a 2D image centroid for each patch box 212, and uses the absolute depth values to project the box centroid into 3D space 211. Siamese neural networks such as the architecture shown in FIG. 1 use two identically configured networks trained using input data. The two sub-networks use a common set of weights, and converge into a function that is configured to learn differences between inputs presented to the two sub-networks. A contrastive function is used to receive the outputs of the sub-networks to calculate a similarity between the two inputs. The output of the contrastive function may be used to update the weights for subsequent learning iterations. According to embodiments in this description, the sampling layer 121 associated with the Siamese neural network organizes identified patch representations in the two input depth images as pairs having one patch from each input image. Sampling layer 121 further assigns a positive label to a pair of patches if measured distances of features in the patches in 3D space is lower than an established threshold, and a negative label otherwise. The threshold may be determined based on accuracy requirements for a given application. For example, the threshold may be computed empirically via cross validation using a validation dataset. The sampling layer 121 computes outputs containing the pair representations including the box label and associated feature vector along with a vector of labels indicating whether each pair of boxes is determined as a positive correlation or a negative non-correlation 230.

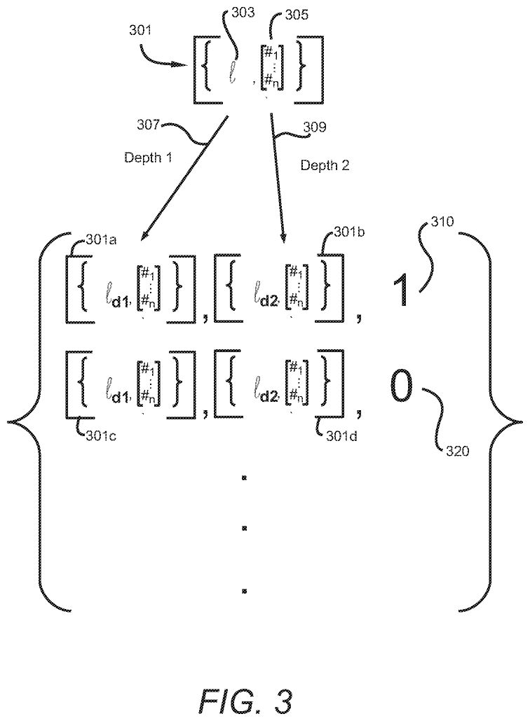

FIG. 3 is an illustration of a representation of patch pairs for two depth images according to aspects of embodiments of this disclosure. Each candidate box or patch for each depth image is analyzed to determine if the patch contains certain features in the 3D space represented in the depth images that are of interest for further consideration. Each patch may be denoted by a vector 301 containing a label 303 identifying the patch within the overall image, and a vector of numeric values 305 which contain information relating to the features captured in the patch. The numeric values represent one or more characteristics of the features contained in the patch. For example, numeric values may be representative of characteristics such as, color, distance, intensity as well as other characteristics descriptive of the captured features.

According to embodiments of the present invention, patches from two input depth images are arranged in pairs and each pair is evaluated to determine if features contained in each patch of the pair correspond and represent the same feature in the 3D space. If features contained in each patch of the pair of patches are found to correspond to the same actual object, a positive label is associated with that pair of patches. If features in each patch of the pair of patches are found to correspond to dissimilar objects, the pair of patches is associated with a negative label.

Referring again to FIG. 3, one patch representation associated with a first depth image 307 and a second patch representation associated with a second depth image 309 are arranged in pairs. A first pair of patches includes one patch representation from the first depth image 301a and a second patch representation from the second depth image 301b. The pair of patch representations 301a, 301b are analyzed to determine if features in each of the patches in the pair of patch representations contain features contained in the feature vector 305 that are within a predetermined distance of each other in the 3D space. If the features are closer to each other in 3D space than a pre-determined threshold, a positive label of “1” 310 is associated with the pair of patch representations 301a, 301b. Additional pairings of patch representations including one patch representation from the first depth image 307 and one patch representation from the second depth image may be arranged and analyzed for correlations of features in the pair of patch representations. In cases where a pair of patch representations 301c, 301d are analyzed and features are determined to be farther from each other than the pre-determined threshold, a negative label of “0” 320 may be associated with the pair of patch representations 301c, 301d.

A set of patch representation pairs and corresponding positive or negative correlation labels may be provided as an output of the sampling layer shown in FIG. 2. From this output, a pose of an object may be determined via a neural network trained with the annotated patch representation information.

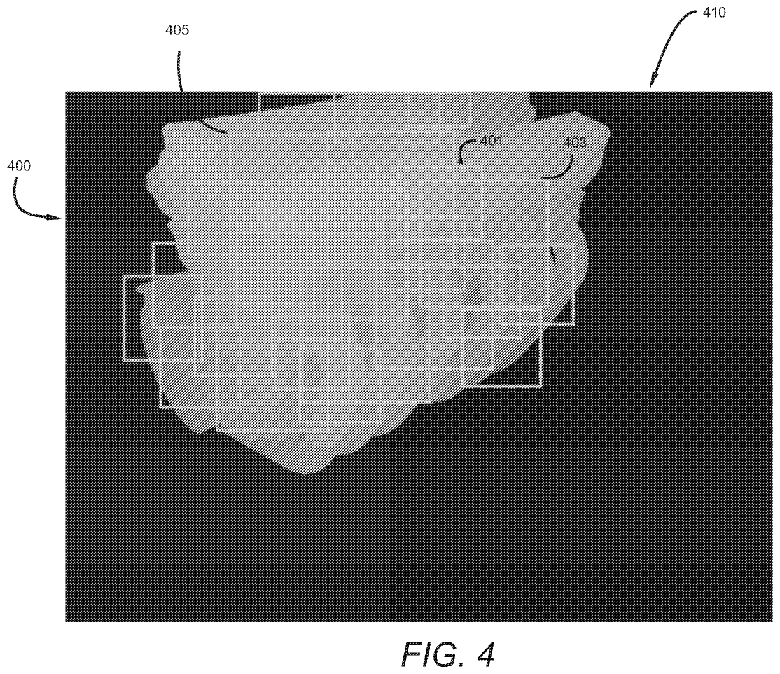

FIG. 4 is an example of a depth image and the selection of candidate patches within the depth image according to aspects of embodiments of this disclosure. The depth image 400 includes one or more features of interest 410. The depth image 400 is analyzed for potential features of interest 410 and candidate boxes or patches 401, 403, 405 are selected as candidate boxes containing the features of interest 410. Each patch 401, 403, 405 defines a rectangular subset of the overall depth image 400. By selecting a plurality of patches, the features of the image may be learned without having to account for additional information in the depth image 400 including background and noise.

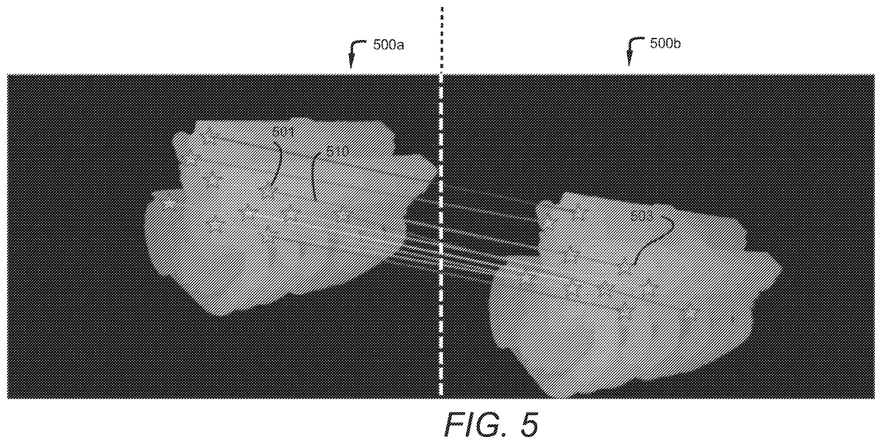

FIG. 5 is an example of a feature matching between two depth images according to aspects of embodiments of this disclosure. A first depth image 500a and a second depth image 500b are input to a learning system for feature matching. In the first depth image 500a, a feature of interest 501 is identified. In the second depth image 500b, the same feature of interest is identified 503 is identified and a match 510 is made between the two features 501, 503 in the images 500a, 500b. Feature matching performed between the patches in the two images allows the system to establish correspondences, to indicate if a depth image from a given view is directed to a particular feature. This information may be utilized to determine relative rotation and translation between the two images.

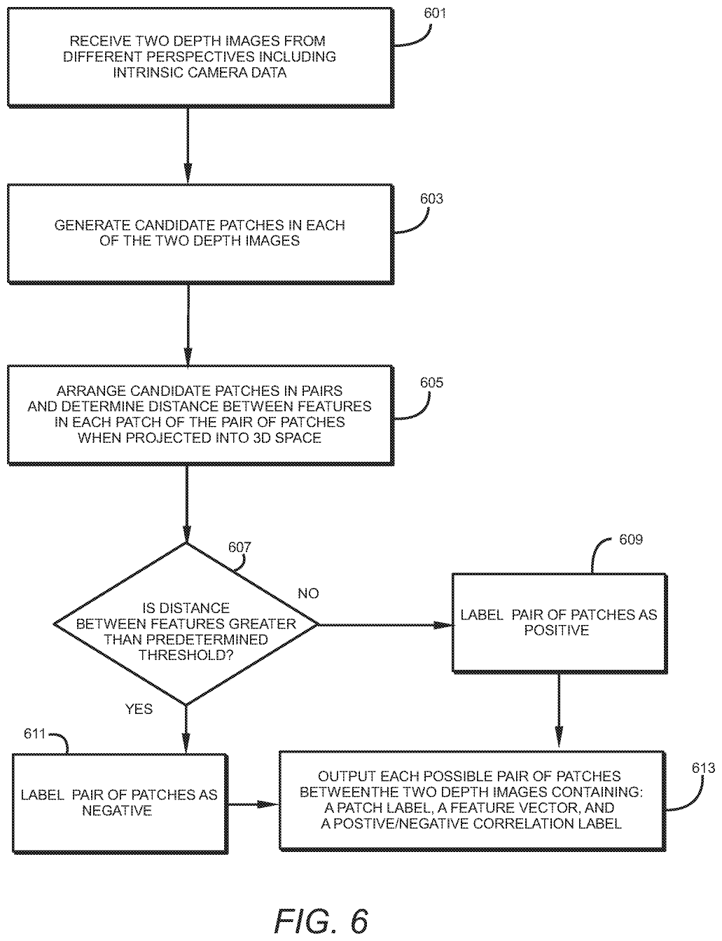

FIG. 6 is a process flow diagram for a method of learning view-invariant patch representations according to aspects of embodiments of the present disclosure. According to the method two depth images are received. The two depth images are images captured from different perspectives and include intrinsic data relating to the image capture device that captured the depth image 601. Candidate patches are generated in each of the two depth images 603. Candidate patches are selected based on a perceived likelihood that the candidate patch contains a feature of interest captured in the depth image. Each candidate patch of the first depth image is paired with each candidate patch identified in the second depth image and distances between features in the first patch of the pair and the second patch of the pair when the features are projected into 3D space 605. After the distance measurement, each pair of patches is considered to determine if a distance between features in each patch of the pair of patches exceeds a pre-determined threshold 607. If the distance between features exceeds the threshold, the pair of patches is labeled as negative 611. If the distance is smaller than the threshold, then the pair of patches is labeled as positive 609. An output containing each possible pair of patches between the two depth images contains a patch label to identify the patch, a feature vector, and the positive/negative label to indicate a correlation to a given feature being identified in both patches of the pair of patches 613. After the pairs of patches are generated, this data is used in conjunction with the contrastive loss technique to train the neural network.

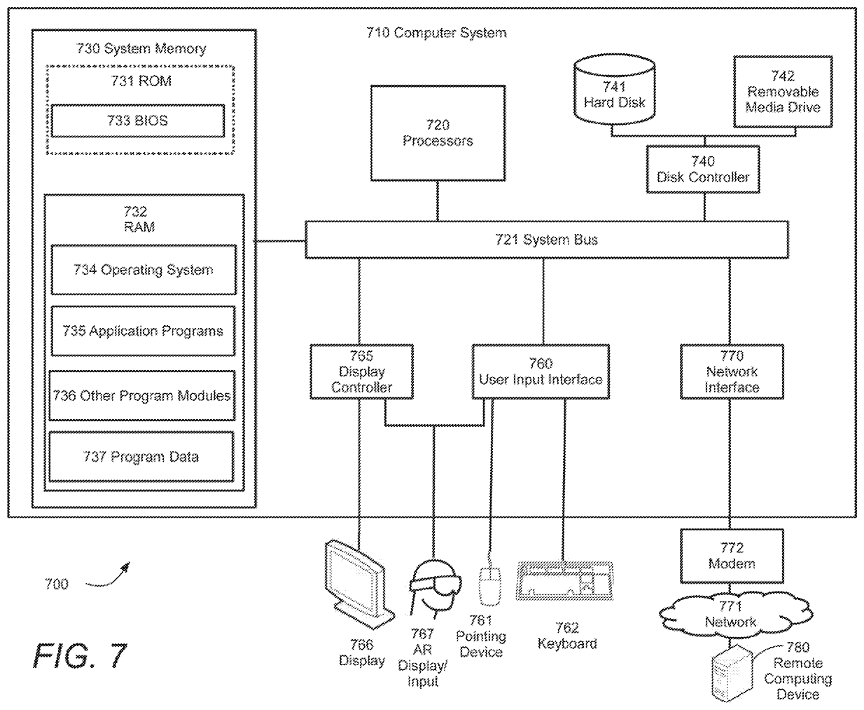

FIG. 7 illustrates an exemplary computing environment 700 within which embodiments of the invention may be implemented. Computers and computing environments, such as computer system 710 and computing environment 700, are known to those of skill in the art and thus are described briefly here.

As shown in FIG. 7, the computer system 710 may include a communication mechanism such as a system bus 721 or other communication mechanism for communicating information within the computer system 710. The computer system 710 further includes one or more processors 720 coupled with the system bus 721 for processing the information.

The processors 720 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general-purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 7, the computer system 710 also includes a system memory 730 coupled to the system bus 721 for storing information and instructions to be executed by processors 720. The system memory 730 may include computer readable storage media in the form of volatile and/or nonvolatile memory, such as read only memory (ROM) 731 and/or random-access memory (RAM) 732. The RAM 732 may include other dynamic storage device(s) (e.g., dynamic RAM, static RAM, and synchronous DRAM). The ROM 731 may include other static storage device(s) (e.g., programmable ROM, erasable PROM, and electrically erasable PROM). In addition, the system memory 730 may be used for storing temporary variables or other intermediate information during the execution of instructions by the processors 720. A basic input/output system 733 (BIOS) containing the basic routines that help to transfer information between elements within computer system 710, such as during start-up, may be stored in the ROM 731. RAM 732 may contain data and/or program modules that are immediately accessible to and/or presently being operated on by the processors 720. System memory 730 may additionally include, for example, operating system 734, application programs 735, other program modules 736 and program data 737.

The computer system 710 also includes a disk controller 740 coupled to the system bus 721 to control one or more storage devices for storing information and instructions, such as a magnetic hard disk 741 and a removable media drive 742 (e.g., floppy disk drive, compact disc drive, tape drive, and/or solid-state drive). Storage devices may be added to the computer system 710 using an appropriate device interface (e.g., a small computer system interface (SCSI), integrated device electronics (IDE), Universal Serial Bus (USB), or FireWire).

The computer system 710 may also include a display controller 765 coupled to the system bus 721 to control a display or monitor 766, such as a cathode ray tube (CRT) or liquid crystal display (LCD), for displaying information to a computer user. The computer system includes input interface 760 and one or more input devices, such as a keyboard 762 and a pointing device 761, for interacting with a computer user and providing information to the processors 720. The pointing device 761, for example, may be a mouse, a light pen, a trackball, or a pointing stick for communicating direction information and command selections to the processors 720 and for controlling cursor movement on the display 766. The display 766 may provide a touch screen interface which allows input to supplement or replace the communication of direction information and command selections by the pointing device 761. In some embodiments, an augmented reality device 767 that is wearable by a user, may provide input/output functionality allowing a user to interact with both a physical and virtual world. The augmented reality device 767 is in communication with the display controller 765 and the user input interface 760 allowing a user to interact with virtual items generated in the augmented reality device 767 by the display controller 765. The user may also provide gestures that are detected by the augmented reality device 767 and transmitted to the user input interface 760 as input signals.

The computer system 710 may perform a portion or all of the processing steps of embodiments of the invention in response to the processors 720 executing one or more sequences of one or more instructions contained in a memory, such as the system memory 730. Such instructions may be read into the system memory 730 from another computer readable medium, such as a magnetic hard disk 741 or a removable media drive 742. The magnetic hard disk 741 may contain one or more datastores and data files used by embodiments of the present invention. Datastore contents and data files may be encrypted to improve security. The processors 720 may also be employed in a multi-processing arrangement to execute the one or more sequences of instructions contained in system memory 730. In alternative embodiments, hard-wired circuitry may be used in place of or in combination with software instructions. Thus, embodiments are not limited to any specific combination of hardware circuitry and software.

As stated above, the computer system 710 may include at least one computer readable medium or memory for holding instructions programmed according to embodiments of the invention and for containing data structures, tables, records, or other data described herein. The term “computer readable medium” as used herein refers to any medium that participates in providing instructions to the processors 720 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 741 or removable media drive 742. Non-limiting examples of volatile media include dynamic memory, such as system memory 730. Non-limiting examples of transmission media include coaxial cables, copper wire, and fiber optics, including the wires that make up the system bus 721. Transmission media may also take the form of acoustic or light waves, such as those generated during radio wave and infrared data communications.

The computing environment 700 may further include the computer system 710 operating in a networked environment using logical connections to one or more remote computers, such as remote computing device 780. Remote computing device 780 may be a personal computer (laptop or desktop), a mobile device, a server, a router, a network PC, a peer device or other common network node, and typically includes many or all of the elements described above relative to computer system 710. When used in a networking environment, computer system 710 may include modem 772 for establishing communications over a network 771, such as the Internet. Modem 772 may be connected to system bus 721 via user network interface 770, or via another appropriate mechanism.

Network 771 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 710 and other computers (e.g., remote computing device 780). The network 771 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 771.

An executable application, as used herein, comprises code or machine-readable instructions for conditioning the processor to implement predetermined functions, such as those of an operating system, a context data acquisition system or other information processing system, for example, in response to user command or input. An executable procedure is a segment of code or machine-readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

What is claimed is:

1. A method for learning view-invariant representations in a pair of images comprising:
receiving a pair of images from a pair of image capture devices;
generating a plurality of candidate patches in each image in the pair of images;
arranging each of the candidate patches of a first image of the pair of with each of the candidate patches of a second image of the pair of images to create a plurality of patch pairs;
identifying features in the patches of each patch pairs;
measuring a distance between a feature of the first patch in the patch pair to a corresponding feature of the second patch in the patch pair;
comparing the distance between corresponding features in the patches of each pair of patches to a threshold; and
labeling the pair of patches as positive or negative based on the comparison of the distance to the threshold.

2. The method of claim 1, wherein each image of the pair of images is a depth image.

3. The method of claim 1, further comprising:
projecting the identified features in the patches into three-dimensional space.

4. The method of claim 1, further comprising:
labelling a patch pair as positive if the measured distance is less than the threshold and as negative if the measured distance is greater than the threshold.

5. The method of claim 1, wherein receiving the pair of images further comprises:
receiving intrinsic information relating to the image capture device used to capture the corresponding received image.

6. The method of claim 1, wherein receiving the pair of images further comprises:
receiving pose information relating to the spatial position of the image capture device that captured the image.

7. The method of claim 1, wherein the identified features are stored as a feature vector.

8. The method of claim 1, further comprising:
outputting a set of labeled patch pairs, each labeled patch pair comprising a patch pair label identifying the patch pair, a feature vector associated with the patch pair, and a positive/negative label indicative of a correlation of a feature identified in the first patch of the patch pair and a feature identified in the second patch of the patch pair.

9. The method of claim 1, wherein the plurality of candidate patches of the first image and the second image are generated by a pre-trained convolutional neural network (CNN).

10. The method of claim 9, wherein the candidate patches of the first image are generated by a first CNN and the candidate patches of the second image are generated by a second CNN, the first and second CNNs being arranged in a Siamese network configuration.

11. The method of claim 1, wherein the plurality of candidate patches of the first image and the candidate patches of the second image are selected based on a likelihood that the patch contains an object of interest captured in the image.

12. The method of claim 1, wherein the pair of images are captured from one given space, and the first image is captured from a first perspective and the second image is captured from second perspective.

13. The method of claim 1, further comprising:
providing a set of labeled patches to a visual analysis application.

14. The method of claim 13, further comprising:
receiving an image in the visual analysis application;
analyzing the received image to identify patches of interest in the received image that has a given likelihood to contain an object of interest; and
comparing the patch of interest to asset of labeled patches to identify the object of interest.

15. The method of claim 14, further comprising:
estimating an object pose in the received image based on the comparison to the set of labeled patches.

16. The method of claim 1, further comprising:
performing a contrastive loss technique on the set of labeled pairs of patches; and
using the results of the contrastive loss technique to train a neural network.

17. A system for learning view invariant image patch representations comprising:
a first image capture device;
a second image capture device;
a Siamese convolutional neural network (CNN) configured to receive a first image from the first image capture device and a second image from the second image capture device and generate a plurality of candidate patches; and
a sampling layer configured to receive a plurality of candidate patches from a first CNN, and a plurality of candidate patches from the second CNN, the sampling layer configured to arrange the candidate patches in pairs, compare distances between features in each patch of the pair of patches and label each pair of patches as positive or negative based on a comparison of the distances to a threshold.

18. The system of claim 17, further comprising:
a set of weights applied to the first CNN and the second CNN.

19. The system of claim 17, further comprising:
a visual analysis application configured to receive a set of the labeled patches and an image, the visual analysis application configured to identify a pose of an object of interest in the image based on a comparison of the image to the set of labeled patches.

20. The system of claim 17, further comprising:
a set of labeled patch pairs created by the sampling layer, each labeled patch pair comprising:
a label identifying the first patch and the second patch associated with the patch pair;
a first feature vector associated with the first patch;
a second feature vector associated with the second patch; and
a binary label associated with the pair of patches, the binary label indicative of a positive or negative correlation between the first feature vector and the second feature vector.

21. The system of claim 20, further comprising:
a visual analysis application configured to receive a set of labeled patches from a neural network trained based on the set of labeled patch pairs and a captured image and produce an object pose for an object in the captured image based on the set of labeled patches.

22. The system of claim 21, wherein, each labeled patch in the set of labeled patches comprises:
a pose annotation identifying a perspective of the training image used to create the patches; and
a feature vector associated with the patch.
